(19) United States
(12) Patent Application Publication
(10) Pub. No.: US 2025/0018775 A1
(43) Pub. Date: Jan. 16, 2025

(54) GOLF CART FRINGE

(71) Applicant: June Ashworth Hood, Smithville, TX (US)

(72) Inventor: June Ashworth Hood, Smithville, TX (US)

(21) Appl. No.: 18/349,697

(22) Filed: Jul. 10, 2023

Related U.S. Application Data
(60) Provisional application No. 63/414,286, filed on Oct. 7, 2022.

(51) Int. Cl. B60J 7/00

(52) U.S. Cl. CPC B60J 7/0023

(57) ABSTRACT

A golf cart fringe. The golf cart fringe includes a body and a first stretch layer. The first stretch layer includes an elastic material and a portion of the body surrounding the elastic material. The golf cart fringe also includes a second stretch layer. The second stretch layer includes an elastic material and a portion of the body surrounding the elastic material. The second stretch layer is parallel to the first stretch layer.

### CROSS-REFERENCE TO RELATED APPLICATIONS

This application claims the benefit of and priority to U.S. Provisional Patent Application Ser. No. 63/414,286 filed on Oct. 7, 2022, which application is incorporated herein by reference in its entirety.

### BACKGROUND OF THE INVENTION

Golf carts are ubiquitous in many communities. They not only are used for golf but have become common as a means of transportation within a local area. However, golf carts don't have a lot of variety outside a number of expensive customizations such as paint jobs or “wraps” placed on the cart.

Further, there are very few ways to create additional shade within the golf cart. In particular, most golf carts have a canopy for shade, but nothing else is done to create shade for the users. Rain covers added to the golf cart suffer from a number of drawbacks, such as difficulty of installation or installation that requires permanent changes to the cart.

Accordingly, there is a need in the art for a fringe that can be placed on the cart which can be used to customize the cart. Further, there is a need in the art for a fringe that provides shade to users.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a golf cart fringe. The golf cart fringe includes a body and a first stretch layer. The first stretch layer includes an elastic material and a portion of the body surrounding the elastic material. The golf cart fringe also includes a second stretch layer. The second stretch layer includes an elastic material and a portion of the body surrounding the elastic material. The second stretch layer is parallel to the first stretch layer.

Another example embodiment includes a golf cart fringe. The golf cart fringe includes a body, where the body includes a circular piece of fabric, and one or more folds in the body. The golf cart fringe moreover includes a first stretch layer. The first stretch layer includes an elastic material and a portion of the body surrounding the elastic material. The golf cart fringe also includes a second stretch layer. The second stretch layer includes an elastic material and a portion of the body surrounding the elastic material. The second stretch layer is parallel to the first stretch layer.

Another example embodiment includes a golf cart. The golf cart includes a cart, where the cart is a motorized vehicle configured for use on a golf course and a canopy attached to the cart, where the canopy is configured to provide shade to a driver of the cart. The golf cart fringe includes a body, where the body includes a circular piece of fabric, and one or more folds in the body. The golf cart fringe moreover includes a first stretch layer on a top surface of the canopy. The first stretch layer includes an elastic material and a portion of the body surrounding the elastic material. The golf cart fringe also includes a second stretch layer on a bottom surface of the canopy. The second stretch layer includes an elastic material and a portion of the body surrounding the elastic material. The second stretch layer is parallel to the first stretch layer. The body between the first stretch layer and the second stretch layer rests on an edge of the canopy.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates the example of the golf cart fringe when not in use;

FIG. 1B illustrates the example of the golf cart fringe when placed on a golf cart;

FIG. 2A illustrates a front view of an example of a golf cart and a golf cart fringe; and

FIG. 2B illustrates a side view of an example of a golf cart and a golf cart fringe.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

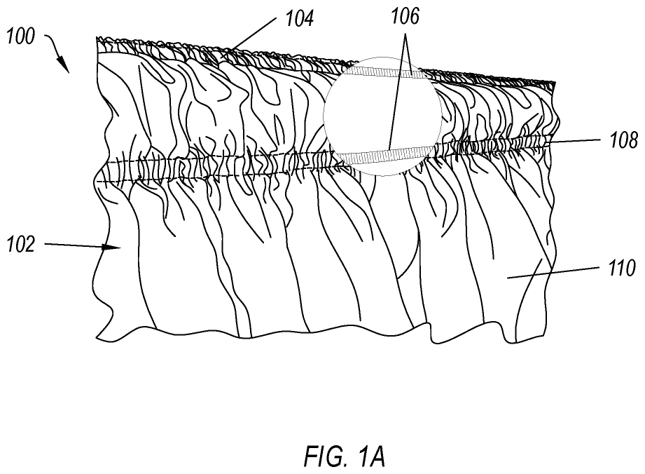

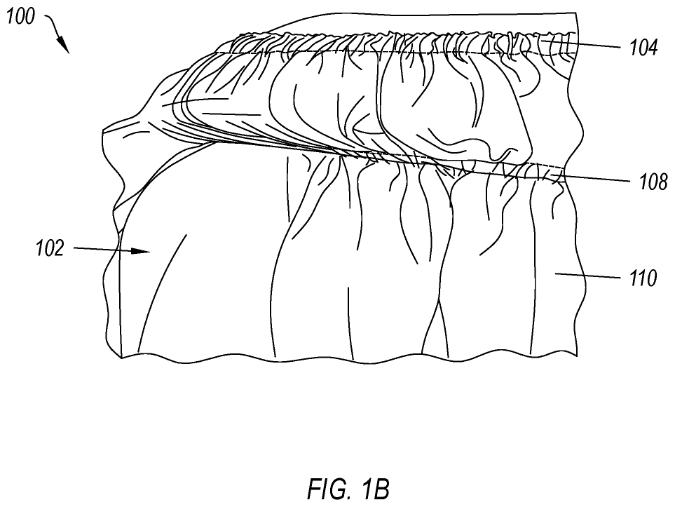

FIGS. 1A and 1B (collectively “FIG. 1”) illustrate an example of a golf cart fringe 100. FIG. 1A illustrates the example of the golf cart fringe 100 when not in use; and FIG. 1B illustrates the example of the golf cart fringe 100 when placed on a golf cart. The golf cart fringe 100 is configured to be placed on a golf cart to decorate and personalize the golf cart. This allows a user to have a personalized experience with the golf cart. The golf cart fringe 100 does not permanently affix to the golf cart which prevents damage to the golf cart and allows the user to change the golf cart fringe 100 when desired. As used in the specification and the claims, the phrase “configured to” denotes an actual state of configuration that fundamentally ties recited elements to the physical characteristics of the recited structure. That is, the phrase “configured to” denotes that the element is structurally capable of performing the cited element but need not necessarily be doing so at any given time. Thus, the phrase “configured to” reaches well beyond merely describing functional language or intended use since the phrase actively recites an actual state of configuration.

FIG. 1 shows that the golf cart fringe 100 can include a body 102. The body 102 is the main decorative portion of the golf cart fringe 100. The body 102 can include a textile. A textile can include any flexible material made by creating an interlocking network of yarns or threads, which are produced by spinning raw fibers (from either natural or synthetic sources) into long and twisted lengths. Textiles are then formed by weaving, knitting, crocheting, knotting, tatting, felting, or braiding these yarns together. For example, the body 102 can include a circular piece of fabric. The fabric can include any desired material, such as fade resistant indoor/outdoor performance fabric made of acrylic or polyester.

The related words “fabric” and “cloth” and “material” are often used in textile assembly trades (such as tailoring and dressmaking) as synonyms for textile. However, there are subtle differences in these terms in specialized usage. A textile is any material made of interlacing fibers, including carpeting and geotextiles, which may not necessarily be used in the production of further goods, such as clothing and upholstery. A fabric is a material made through weaving, knitting, spreading, felting, stitching, crocheting or bonding that may be used in the production of further products, such as clothing and upholstery, thus requiring a further step of production. Cloth may also be used synonymously with fabric, but often specifically refers to a piece of fabric that has been processed or cut. Nevertheless, as used herein “textile,” “fabric,” “cloth,” and “material” are synonyms unless otherwise specified.

The body 102 can be pleated, straight, have scalloped edges, etc. This allows the user to have many options for personalizing the golf cart fringe. Likewise, the body 102 can include other decorative items, such as ribbons, tassels, bows, etc. which hang from the body 102 when installed on a golf cart.

FIG. 1 also shows that the body 102 can include a first stretch layer 104. The first stretch layer 104 allows the golf cart fringe 100 to be attached to a golf cart. I.e., the first stretch layer 104 will be used to releasably secure the golf cart fringe 100 to the golf cart. The first stretch layer 104 is at or near the top edge of the golf cart fringe.

FIG. 1 further shows that the first stretch layer 104 can be a portion of the body 102 surrounding an elastic material 106. In physics and materials science, elasticity is the ability of a body to resist a distorting influence and to return to its original size and shape when that influence or force is removed. Solid objects will deform when adequate loads are applied to them; if the material is elastic, the object will return to its initial shape and size after removal and if the material is plastic, the object fails to return to its initial shape and size and instead remains in its deformed state. I.e., when an elastic material is deformed due to an external force, it experiences internal resistance to the deformation and restores it to its original state if the external force is no longer applied.

The elastic material 106 of the first stretch layer 104 can be any desired material. For example, the elastic material 106 can include an elastomer such as natural or synthetic rubber. Rubber-like solids with elastic properties are called elastomers. Polymer chains are held together in elastomers by relatively weak intermolecular bonds, which permit the polymers to stretch in response to macroscopic stresses. The long polymer chains cross-link during curing (i.e., vulcanizing). The molecular structure of elastomers can be imagined as a ‘spaghetti and meatball’ structure, with the meatballs signifying cross-links. The elasticity is derived from the ability of the long chains to reconfigure themselves to distribute an applied stress. The covalent cross-linkages ensure that the elastomer will return to its original configuration when the stress is removed. Rubber consists of polymers of the organic compound isoprene, with minor impurities of other organic compounds.

FIG. 1 additionally shows that the body 102 can include a second stretch layer 108. Similar to the first stretch layer 104, the second stretch layer 108 can be a portion of the body 102 surrounding an elastic material 106. The second stretch layer 108 works with the first stretch layer 104 to attach the golf cart fringe 100 to a golf cart. I.e., the first stretch layer 104 and the second stretch layer 108 will be used to releasably secure the golf cart fringe 100 to the golf cart. The second stretch layer 108 is parallel to the first stretch layer 104 and is between 4 and 5 inches from the first stretch layer 104.

The distance between the first stretch layer 104 and the second stretch layer 108 is critical to ensure that the golf cart fringe 100 remains on the golf cart. In particular, the distance between the first stretch layer 104 and the second stretch layer 108 is critical to ensure that the golf cart fringe 100 “pinches” the canopy of the golf cart, allowing the golf cart fringe 100 to remain in place during operation of the golf cart. Fabric that isn't big enough won't work for a golf cart fringe. Likewise, hook and loop fasteners, plastic hooks, metal hooks, string/rope all failed to produce the desired results as they did not have the necessary hold and required permanent modifications to the cart.

FIG. 1 moreover shows that the golf cart fringe 100 can include one or more folds 110. The one or more folds 110 allow the body 102 to stretch to different sizes. I.e, the one or more folds allow the golf cart fringe 100 to be placed on canopies of different sizes and shapes. In particular, the one or more folds 110 allow the body 102 to change size when the first stretch layer 104 and the second stretch layer 108 go from resting to fully stretched and vice versa. Multiple sizes are contemplated herein.

For example, for a standard size, the length of the body 102 can be between 100 inches and 160 inches when the first stretch layer 104 and the second stretch layer 108 are in their resting state. In particular, the length of the body 102 can be approximately 130 inches when the first stretch layer 104 and the second stretch layer 108 are in their resting state. In contrast, for a standard size the length of the body 102 can be between 155 inches and 235 inches when the first stretch layer 104 and the second stretch layer 108 are in their fully stretched state. In particular, the length of the body 102 can be approximately 195 inches when the first stretch layer 104 and the second stretch layer 108 are in their fully stretched state. As used in the specification and the claims, the term approximately shall mean that the value is within 10% of the stated value, unless otherwise specified.

In contrast, for an extended size, the length of the body 102 can be between 135 inches and 195 inches when the first stretch layer 104 and the second stretch layer 108 are in their resting state. In particular, the length of the body 102 can be approximately 165 inches when the first stretch layer 104 and the second stretch layer 108 are in their resting state. In contrast, for a extended size the length of the body 102 can be between 200 inches and 300 inches when the first stretch layer 104 and the second stretch layer 108 are in their fully stretched state. In particular, the length of the body 102 can be approximately 250 inches when the first stretch layer 104 and the second stretch layer 108 are in their fully stretched state.

The one or more folds 110 can be critical to ensure that the golf cart fringe 100 resists damage. In particular, the one or more folds 110 prevent the first stretch layer 104 and the second stretch layer 108 from becoming overextended. As the body 102, first stretch layer 104 and the second stretch layer 108 are stretched to be placed on a canopy the one or more folds 110 straighten, allowing the body 102 to become larger in size. However, as the one or more folds 110 become completely flattened, then the fabric of the body increasingly creates resistance to further stretching. This prevents the elastic material 106 from overextending and reaching a fracture point (the point at which the elastic material 106 is damaged and will no longer return to its prestretch length).

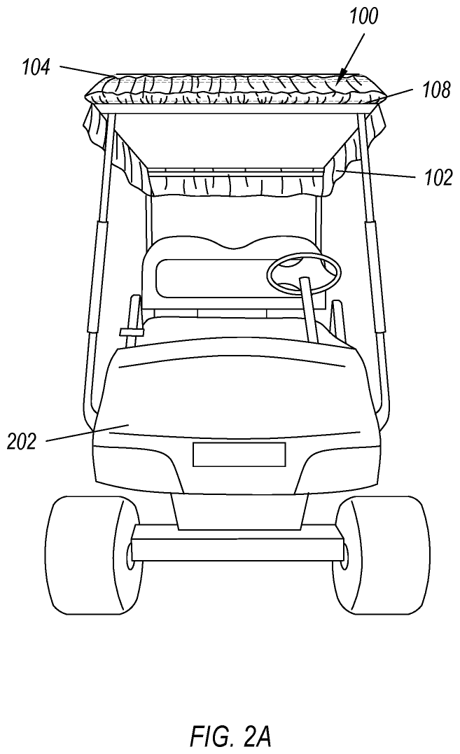

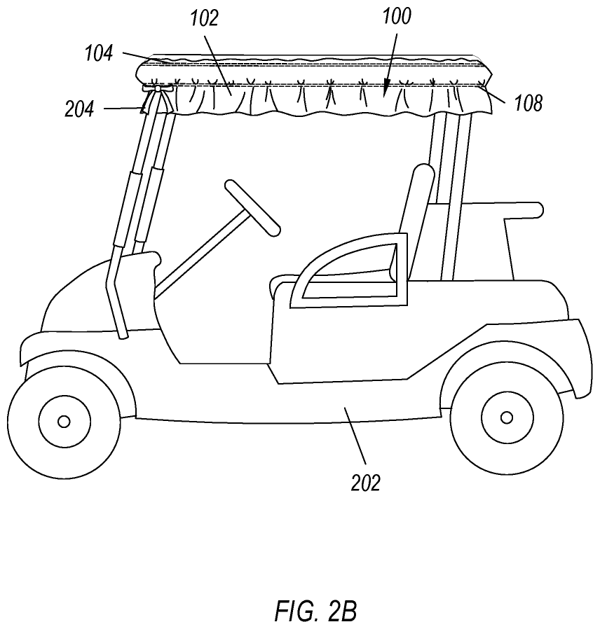

FIGS. 2A and 2B (collectively “FIG. 2”) illustrates an example of a golf cart 202 and a golf cart fringe 100. FIG. 2A illustrates a front view of an example of a golf cart 202 and a golf cart fringe 100; and FIG. 2B illustrates a side view of an example of a golf cart 202 and a golf cart fringe 100. The golf cart fringe 100 allows a user to personalize his/her golf cart 202. In particular, the golf cart fringe 100 goes around the canopy of the golf cart 202, creating a decorative layer.

FIG. 2 shows that the golf cart fringe 100 does not include any of the body 102 below the second stretch layer 108. This prevents the golf cart fringe 100 from impeding the view of the user. I.e., having the body 102 end at the second stretch layer 108 prevents the golf cart fringe 100 from blocking the view of the golf cart driver.

FIG. 2 also shows that the golf cart fringe 100 does not cover the canopy of the golf cart 202. This is critical for a number of reasons. First, this makes changing the golf cart fringe 100 easy. To place the golf cart fringe 100, the user simply places the golf cart fringe 100 with the second stretch layer 108 below the canopy and the first stretch layer 104 above the canopy and pulls. The two stretch layers pull the body 102 tight against the canopy, keeping the golf cart fringe 100 in place. Likewise, for removal the user can pull up or down on one corner of the golf cart fringe 100 so that both the first stretch layer 104 and the second stretch layer 108 are both above or below the canopy, which prevents the elastic tension from keeping the golf cart fringe 100 in place, and then continues around the canopy.

Second, other attachments require permanent attachment mechanisms, such as snaps or hook and loop fasteners, to be attached to the canopy, which ruin the aesthetics of the golf cart and can cause permanent damage. To eliminate this, many rain covers are placed under the canopy, which requires the removal of the canopy, installation of rails, reattachment of the canopy the attachment of the rain cover. This process is time consuming and prevents quick changes of the cover.

Third, the golf cart fringe 100 requires less fabric than covers which completely cover the canopy. Indeed, the golf cart fringe 100 requires less than half of the fabric of other covers, greatly reducing the cost of the golf cart fringe 100. In addition, others rarely see the top of the canopy, meaning that most users don't care whether a decorative addition, such as the golf cart fringe 100 covers the top of the canopy. I.e., covering the canopy creates additional cost without additional benefit.

Fourth, different canopies are different sizes and shapes. A full covering requires that the covering be sized and shaped to match the canopy or the covering doesn't look good. I.e., a full covering is not adaptable to different sizes and shapes of canopies. In contrast, the golf cart fringe 100 can adapt to a number of different sizes and shapes.

Finally, covering the canopy creates problems when driving the golf cart 202. In particular, when driving a full covering on the canopy allows for air to get between the canopy and the covering, which can create pressure which will cause the covering to pop off. Having the golf cart fringe 100 not cover the canopy prevents this and allows the golf cart fringe 100 to more easily remain in place. Thus, by not covering the canopy, the golf cart fringe 100 is easier to change, not permanently attached, more affordable for the user, adaptable to different sizes and shapes of golf cart canopy and prevents air from forcing the golf cart fringe 100 off the golf cart 102 during driving.

FIG. 2 further shows that the golf cart fringe 100 can include one or more decorative items 204. For example, the one or more decorative times can include ribbons, tassels, bows, etc. which hang from the body 102 when installed on a golf cart. These decorative items 204 allow a user to personalize the golf cart fringe 100.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A golf cart fringe, the golf cart fringe comprising:
a body;
a first stretch layer, wherein the first stretch layer includes:
an elastic material; and
a portion of the body surrounding the elastic material; and
a second stretch layer, wherein the second stretch layer:
includes:
an elastic material; and
a portion of the body surrounding the elastic material; and
is parallel to the first stretch layer.

2. The golf cart fringe of claim 1, wherein the body includes a circular piece of fabric.

3. The golf cart fringe of claim 2, wherein the circular piece of fabric is between 100 inches and 160 inches long when the first stretch layer and the second stretch layer are in their resting state.

4. The golf cart fringe of claim 3, wherein the circular piece of fabric is approximately 130 inches long when the first stretch layer and the second stretch layer are in their resting state.

5. The golf cart fringe of claim 4, wherein the circular piece of fabric is between 155 inches and 235 inches long when the first stretch layer and the second stretch layer are in their fully stretched state.

6. The golf cart fringe of claim 5, wherein the circular piece of fabric is approximately 195 inches long when the first stretch layer and the second stretch layer are in their fully stretched state.

7. The golf cart fringe of claim 2, wherein the circular piece of fabric is:
approximately 165 inches long when the first stretch layer and the second stretch layer are in their resting state and
approximately 250 inches long when the first stretch layer and the second stretch layer are in their fully stretched state.

8. The golf cart fringe of claim 1, wherein the second stretch layer is between 4 and 5 inches from the first stretch layer.

9. The golf cart fringe of claim 1, wherein the elastic material of the first stretch layer includes a natural rubber.

10. The golf cart fringe of claim 1, wherein the elastic material of the first stretch layer includes a synthetic rubber.

11. The golf cart fringe of claim 1, wherein the elastic material of the first stretch layer includes an elastomer.

12. A golf cart fringe, the golf cart fringe comprising:
a body, wherein the body includes a circular piece of fabric;
one or more folds in the body;
a first stretch layer, wherein the first stretch layer includes:
an elastic material; and
a portion of the body surrounding the elastic material; and
a second stretch layer, wherein the second stretch layer:
includes:
an elastic material; and
a portion of the body surrounding the elastic material; and
is parallel to the first stretch layer.

13. The golf cart fringe of claim 12, wherein the fabric includes at least one of:
acrylic; and
polyester.

14. The golf cart fringe of claim 12, wherein the body extends only to the edge of the second stretch layer along a portion of the body's circumference.

15. The golf cart fringe of claim 12 further comprising:
one or more tassels extending from the body.

16. The golf cart fringe of claim 12 further comprising:
one or more ribbons extending from the body.

17. A golf cart, the golf cart comprising:
a cart, wherein the cart is a motorized vehicle configured for use on a golf course;
a canopy attached to the cart, wherein the canopy is configured to provide shade to a driver of the cart;
a golf cart fringe, the golf cart fringe including:
a body, wherein the body includes a circular piece of fabric;
one or more folds in the body;
a first stretch layer on a top surface of the canopy, wherein the first stretch layer includes:
an elastic material; and
a portion of the body surrounding the elastic material; and
a second stretch layer on a bottom surface of the canopy, wherein the second stretch layer:
includes:
an elastic material; and
a portion of the body surrounding the elastic material; and
is parallel to the first stretch layer;
wherein the body between the first stretch layer and the second stretch layer rests on an edge of the canopy.

18. The golf cart fringe of claim 17, wherein the body extends only to the edge of the second stretch layer along a portion of the body's circumference.

19. The golf cart fringe of claim 17, wherein the body extends only to the edge of the first stretch layer.

20. The golf cart fringe of claim 17, wherein the body covers only a portion of the top surface of the canopy.
